(19) United States
(12) Patent Application Publication
(10) Pub. No.: US 2005/0147869 A1
(43) Pub. Date: Jul. 7, 2005

(54) Membrane electrode assembly, fuel cell using same and process for producing them

(76) Inventors: Shuichi Suzuki, Hitachi (JP); Makoto Morishima, Hitachinaka (JP); Yoshiyuki Takamori, Hitachinaka (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/028,215

(22) Filed: Jan. 4, 2005

(30) Foreign Application Priority Data
Jan. 7, 2004 (JP) 20049-001598

(51) Int. Cl. H01M 4/86; H01M 8/10; H01M 4/96; H01M 4/92; H01M 4/88; B05D 5/12

(52) U.S. Cl. 429/42; 429/30; 429/44; 502/101; 427/115

(57) ABSTRACT

It is an object of this invention to provide a high-performance membrane electrode assembly high in adhesiveness to proton-conductive aromatic polymer membrane, low in interfacial resistance and high in voltage-current performance, and a fuel cell using the same. This invention consists in a membrane electrode assembly equipped with an anode electrode having a catalyst layer on one side surface of a proton-conductive aromatic polymer membrane and a cathode electrode on the other side surface of the membrane, wherein said catalyst layer has a catalyst and a n-conjugated aromatic polymer having ion exchanging groups on side chains thereof.

### INCORPORATION BY REFERENCE

The present application claims priority from Japanese application JP2004-001519 filed on Jan. 7, 2004, the content of which is hereby incorporated by reference into this application.

### BACKGROUND OF THE INVENTION

This invention relates to a novel membrane electrode assembly, a manufacturing method of said membrane electrode assembly, a fuel cell, and a manufacturing method of said fuel cell.

In the recent years, the warming tendency of the earth and the pollution of the environment, caused by the large-scale consumption of fossil fuel, have become a serious problem. As a means for coping with this problem, fuel cells using hydrogen as the fuel such as polymer electrolyte fuel cells (PEFC) attract the public interest, replacing the internal combustion engine which burns the fossil fuel. Further, owing to the progress in the electronic techniques, the information terminal instruments and the like are miniaturized year by year, and rapidly being popularized as portable electronic instruments. At the present time, fuel cells using methanol as a fuel, namely the direct methanol fuel cells (DMFC), are being developed.

Such fuel cells are constructed by using, as a central structure thereof, a membrane electrode assembly prepared by providing electrode catalyst layers functioning as anode and cathode on the both surfaces of a solid polymer electrolyte membrane. Generally speaking, the electrode catalyst layers are constructed from a catalyst, a carbon carrier and a proton conductor.

Now, the fluorine type electrolytes typified by perfluorosulfonic acids have a very high chemical stability, because of the C—F linkage which these substances have. Thus, said fluorine type electrolytes are used as a solid polyelectrolyte membrane for the above-mentioned fuel cells.

However, said fluorine type electrolytes are quite expensive because of their unique manufacturing technique. Further, halogen compounds require a special measure in the point of apparatus, in order to cope with the pollution of the environment at the times of synthesis and disposal. Thus, it has been desired to develop a non-fluorine type poly electrolyte as a proton conductor which is cheap and soft to the environment.

As a proton-conductive aromatic polymer film which can be produced at a low cost, a non-fluorine type polyelectrolyte film prepared by introducing sulfonic acid residues into the aromatic rings of a polysulfone having specific repeating units has been proposed (Japanese Patent Kokai Hei 9-245818). Further, it has been proposed in Japanese Patent Kokai 2001-110428 that a catalyst layer comprising a n-conjugated aromatic polymer and a catalyst, said aromatic polymer being a non-fluorine type polyelectrolyte membrane having sulfonic acid groups or alkylsulfonic acid groups on the side chains thereof, can be formed.

As for proton-conductor in the electrode catalyst layer of the membrane electrode assembly using the proton-conductive polymer membrane of Japanese Patent Kokai Hei 9-245818, no suitable material has yet been discovered at the present time. If a fluorine type electrolyte is used, it is poor in adhesiveness with the proton-conductive aromatic polymer membrane, so that the interfacial resistance to the proton shift is great. On the other hand, if the prior proton-conductive aromatic polymer is used, N-methyl-2-pyrrolidinone or the like has to be used as a solvent for the sake of dissolving the proton-conductive aromatic polymer. The use thereof, however, makes worse the dispersibility of carbon carrier, so that good cell characteristic properties are difficult to obtain. Further, it may be possible to make the proton-conductive aromatic polymer soluble in a solvent such as alcohols or water by increasing the number of ion exchanging groups. However, such proton-conductive aromatic polymer is soluble in methanol under the conditions of using the cell, which deteriorates durability and proton conductivity of the electrode catalyst layer.

In Japanese Patent Kokai 2001-110428, the adhesiveness between the fluorine type polyelectrolyte membrane and the n-conjugated aromatic polymer having sulfonic groups or alkylsulfonic acid groups on side chains thereof becomes low, and the interfacial resistance is high.

The object of this invention is to provide a membrane electrode assembly having a low interfacial resistance to proton-conductive aromatic polymer membrane, a method for production thereof, a fuel cell using the same, and a method for production thereof.

### SUMMARY OF THE INVENTION

This invention consists in a membrane electrode assembly comprising an anode electrode having a catalyst layer on one side of a proton-conductive aromatic polyelectrolyte membrane and a cathode electrode having a catalyst layer on the other side of said proton-conductive aromatic polyelectrolyte membrane, wherein said catalyst layer has a n-conjugated aromatic polymer having ion exchanging groups on the side chains thereof and a catalyst.

Further, this invention consists in a method for producing a membrane electrode assembly having a step of forming, on one side surface of proton-conductive aromatic polymer membrane, an anode electrode having a catalyst layer comprising a catalyst and a n-conjugated aromatic polymer having ion exchanging groups on the side chains and a step of forming, on the other side surface of the aromatic polymer membrane, a cathode electrode having a catalyst layer comprising a catalyst and a n-conjugated aromatic polymer having ion exchanging groups on side chains thereof.

The above-mentioned step for forming an anode electrode preferably comprises a step of adding a carbon type powdery carrier in which mixed fine powder of platinum and ruthenium or a fine powder of platinum-ruthenium alloy is dispersed and carried to the above-mentioned solution of n-conjugated aromatic polymer to prepare a slurry, a step of coating said slurry onto one surface of said electrolyte membrane, and a step of drying and then forming the coated matter under a pressure.

The above-mentioned step for forming a cathode electrode preferably comprises a step of adding, to the above-mentioned solution of n-conjugated polymer solution, a carbon type powdery carrier in which fine powder of platinum is dispersed and carried to make a slurry, a step of coating said slurry onto one surface of the above-mentioned electrolyte membrane, and a step of drying and then forming the coated matter under a pressure.

Further, this invention consists in a fuel cell equipped with the above-mentioned membrane electrode assembly and having a fuel feeding means for feeding a fuel to the above-mentioned anode electrode, an oxidation gas feeding means for feeding an oxidation gas to the above-mentioned cathode electrode, a combustion waste gas discharging means for discharging the combustion gas of the above-mentioned fuel, and an oxidation waste gas discharging means for discharging the waste gas of the above-mentioned oxidation gas.

Other objects, features and advantages of the invention will become apparent from the following description of the embodiments of the invention taken in conjunction with the accompanying drawings.

### BRIEF DESCRIPTION OF DRAWINGS

FIG. 1 is a cross-sectional schematic view of the fuel cell of this invention.

FIG. 2 is a drawing illustrating the relation between voltage and current density in a fuel cell.

### DESCRIPTION OF REFERENCE NUMERALS

11—anode electrode, 12—Proton-conductive aromatic polymer membrane, 13—Cathode electrode, 14—Outer circuit, 15—Fuel, 16—Carbon dioxide, 17—Oxidation gas, 18—Waste gas

### DETAILED DESCRIPTION OF THE INVENTION

As the n-conjugated aromatic polymer, for example, it is preferable to use polyaniline, polypyrrole, polythiophene, polyfluorene, polyphenylene and the like, which permits the passage of both proton and electron. As the ion exchanging group to be provided on the side chain, sulfonic group and phosphate group are preferred. Introduction of the ion exchanging group makes the n-conjugated aromatic polymer soluble in a solvent such as alcohols, water and the like. The ion exchanging group to be provided on the side chain preferably has electron conductivity while some ion exchanging groups have poor electron conductivity.

As solvent, any solvents may be used without limitation so far as the solvent can be removed after formation of the electrode catalyst layer and does not disturb dispersion of the carbon carrier. For example, the solvents usable include not only water, but also alkylene glycol monoalkyl ethers such as ethylene glycol monomethyl ether, ethylene glycol monoethyl ether, propylene glycol monomethyl ether, propylene glycol monoethyl ether and the like, as well as alcohols such as n-propanol, isopropyl alcohol, t-butyl alcohol and the like, tetrahydrofuran, and the like.

Since the n-conjugated aromatic polymer is superior to fluorine type electrolytes in the adhesiveness to the proton-conductive aromatic polymer membrane and both the materials belong to the same aromatic polymer membrane, it is possible to suppress the interfacial resistance of the proton conduction to a low level.

As the proton-conductive aromatic polymer membrane to be provided at the center of the membrane electrode assembly of this invention, sulfonated polyether ketone, sulfonated polyether sulfone, sulfonated acrylonitrile-butadiene-styrene copolymer, sulfonated polysulfide and the like can be used. Further, as the proton-conductive aromatic polymer membrane, preferable are membranes which permit passage of proton but do not permit passage of electron and which are different from the n-conjugated aromatic polymer.

As the catalyst according to this invention, any catalysts may be used so far as the catalyst accelerates the oxidation reaction of fuel and the reduction reaction of oxidation gas. The catalysts which can be used include metals such as platinum, gold, silver, palladium, iridium, rhodium, ruthenium, iron, cobalt, nickel, chromium, tungsten, manganese, vanadium and the like, and alloys and compounds thereof. Among these catalysts, platinum and alloys thereof are preferable because of superiority in the effect of accelerating the oxidation reaction of fuel and the reduction reaction of oxidation gas.

As the anode catalyst, a material prepared by dispersing and supporting mixed fine particles of platinum and ruthenium or a finely powdered platinum-ruthenium alloy on a carbon type powdery carrier is preferable. As the cathode catalyst, a material prepared by dispersing and supporting finely powdered platinum on a carbon type carrier is preferable. Preferably, a third component selected from iron, tin, rare earth metals and the like is additionally added to the anode catalyst and cathode catalyst of the fuel cell of this invention, for the purpose of stabilizing the electrode catalysts and prolonging the lives thereof.

Preferably, the catalysts are put to use either alone or in a state of dispersion on a carrier typified by carbon materials. At this time, the average particle diameter of the catalyst is preferably in the range of about 1-30 nanometers. The quantity of the catalysts is preferably in the range of 0.01-20 mg/cm² as expressed in the term of anode electrode and cathode electrode, in the state that a membrane electrode assembly has been formed.

As the carbon material, for example, carbon blacks such as furnace black, channel black, acetylene black and the like, fibrous carbon materials such as carbon nanotube and the like, as well as active charcoal, graphite and the like can be used. These materials may be used either alone or in the form of a mixture.

This invention consists in a fuel cell having a fuel feeding means for feeding fuel to the anode electrode, an oxidation gas feeding means for feeding an oxidation gas to the cathode electrode, a burnt waste gas discharging means for discharging a burnt gas of said fuel, and an oxidized waste gas discharging means for discharging the waste gas of said oxidation gas, wherein said anode electrode has, on one side surface of a proton-conductive polyelectrolyte membrane, a catalyst layer comprising a catalyst and a n-conjugated aromatic polymer having ion exchanging groups on the side chains thereof and said cathode electrode has, on the other side surface of the polyelectrolyte membrane, a catalyst layer comprising a catalyst and a n-conjugated aromatic polymer having ion exchanging groups on the side chains thereof, wherein said catalyst layers are electrolytically polymerized.

Further, this invention relates to a method for producing a fuel cell which comprises a fuel feeding means for feeding a fuel to an anode electrode having, on one side surface of a proton-conductive polyelectrolyte membrane, a catalyst layer comprising a catalyst and a n-conductive aromatic polymer having ion exchanging groups on the side chains thereof, an oxidation gas feeding means for feeding an oxidation gas to the cathode electrode having, to the other side of said electrolyte membrane, having a catalyst layer comprising a catalyst and a n-conjugated aromatic polymer having ion exchanging groups on the side chains thereof, a burnt waste gas discharging means for discharging the combustion gas of said fuel, and an oxidized waste gas discharging means for discharging the waste gas of said oxidation gas, wherein the catalyst layers are electrolytically polymerized by at least one step selected from the first step for giving an electric field of plus electrode to the anode electrode and an electric field of minus electrode to the cathode electrode while feeding a fuel to the cathode electrode and the second step for giving an electric field of minus electrode to the anode electrode and an electric field of plus electrode to the cathode electrode while feeding a fuel to the anode electrode. For electrolytically polymerizing the catalyst layers, it is preferable to carry out the second step after the first step.

As has been mentioned above, a n-conjugated aromatic polymer can be electrolytically polymerized by inputting a potential between the electrodes while feeding a fuel, after formation of a fuel cell. By this electrolytic polymerization, the polymer increases its molecular weight, and increases its insolubility in aqueous methanol and acquires a higher durability as a fuel. Further, in the electrolytic polymerization, a higher homogeneity of dispersion between binder and catalyst can be attained than in the case of heating method. Accordingly, by forming a fuel cell and thereafter putting a voltage and carrying out an electrolytic polymerization of the n-conjugated aromatic polymer before usage of the cell, the dissolution into fuel and formed water under the conditions of usage of the cell can be suppressed, and deterioration of electrode catalyst layer can be suppressed to a low level. The voltage applied at this time is preferably 0.5-1.5 V, and time period of application is preferably about 1 minute to 3 hours. If the voltage is lower than 0.5 V or the time period of application is shorter than one minute, the electrolytic polymerization cannot progress smoothly. If the voltage is higher than 1.5 V or the time period of application is longer than 3 hours, the catalyst is dissolved, which is not preferable.

As the fuel fed to the fuel cell using the membrane electrode assembly of this invention, aqueous methanol, hydrogen gas and the like can be referred to, for example. As the oxidation gas, oxygen, air containing oxygen, etc. can be referred to.

According to this invention, a membrane electrode assembly having a low interfacial resistance to proton-conductive aromatic polymer membranes, a method for producing the same, a fuel cell using the same, and a method for producing the same can be provided. Further, the proton-conductive aromatic polymer membrane is suitable for use as an electrode layer formed as a membrane electrode assembly thereof.

### DESCRIPTION OF PREFERRED EMBODIMENT

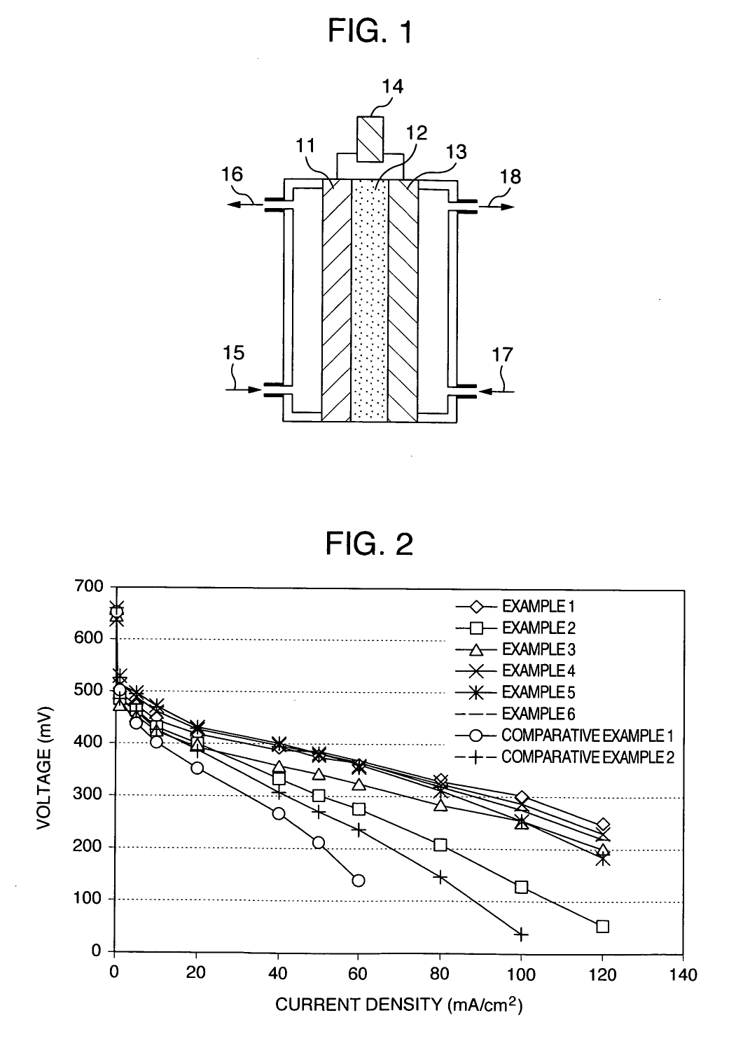

FIG. 1 is a sectional view illustrating the fuel cell of this invention. The fuel cell is constituted of, around a central structure thereof, a membrane electrode assembly of the present example having an anode electrode 11, a cathode electrode 13 and, as a central structure, a proton-conductive aromatic polymer membrane 12. To the anode electrode 11 side, a fuel 15 composed mainly of aqueous methanol or the like is supplied, and carbon dioxide 16 is discharged. To the cathode electrode 13 side, oxidation gas 17 such as oxygen, air or the like is supplied, and a waste gas 18 comprising the unreacted gas in the introduced gas and water is discharged. The anode electrode 11 and the cathode electrode 13 are connected to the outer circuit 14.

The membrane electrode assembly of Example 1 was prepared in the following manner. Thus, a 5% (by weight) aqueous solution of sulfonated polyaniline (manufactured by Aldrich) as a n-conjugated aromatic polymer having ion exchanging groups on side chains thereof was concentrated to a concentration of 10% (by weight). To 15 g of the concentrated solution thus obtained was added 15 g of n-propyl alcohol and concentration of sulfonated polyaniline was adjusted to 5% by weight. The 5% solution thus prepared was stirred at room temperature for one hour. An anode electrode catalyst slurry was prepared by mixing together 30 g of the stirred solution, 3.0 g of water and 3.0 g of 50% (by weight) platinum/ruthenium carrying carbon. Then, the slurry was stirred for 24 hours. The anode electrode catalyst slurry this obtained was coated onto one side surface of a sulfonated polyether sulfone membrane having a thickness of 50 μm as an electrolyte membrane (proton-conductive aromatic membrane 12) so that the weight of platinum/ruthenium came to 2 mg/cm², and dried. The dried coating was then subjected to hot pressing at a temperature of 100-160° C. under a pressure of 120 kg/cm² to form anode electrode 11. The pressure at the time of hot pressing is preferably in the range of 50-200 kg/cm². The forming under pressure may be carried out by means of rolls in place of the hot press, if desired.

In the same manner as in the production of anode electrode, a cathode electrode catalyst slurry was prepared by mixing together 30 g of 5% (by weight) solution of sulfonated polyaniline, 3.0 g of water and 3.0 g of 50% (by weight) platinum-carrying carbon, and the slurry was stirred for 24 hours. The slurry thus obtained was coated onto the other side of the above-mentioned sulfonated polysulfone membrane so that the weight of platinum came to 1 mg/cm², and dried and subjected to hot pressing in the same manner as above to form cathode electrode 13. Thus, a membrane electrode assembly of the present example was obtained.

The membrane electrode assembly thus obtained was made into a fuel cell of FIG. 1. A plus electrode of current-voltage controlling apparatus was connected to the node electrode 11 side, and a minus electrode thereof was connected to the cathode electrode 13 side. While supplying argon gas containing 3% by volume of hydrogen to the cathode electrode 13 side, a voltage of 1 V was applied for 30 minutes. Then, the plus electrode and the minus electrode were interchanged, and a voltage of 1 V was again applied while supplying argon gas containing 3% by volume of hydrogen to the anode electrode 11 side, to polymerize the sulfonated polyaniline electrolytically.

The membrane electrode assembly of Example 2 was prepared in the same manner as in Example 1, except that, after obtaining a membrane electrode assembly by the use of sulfonated polyaniline as a n-conjugated aromatic polymer having ion exchanging groups on side chains thereof, the procedure of subjecting the sulfonated polyaniline to an electrolytic polymerization in an intended manner is not carried out.

The membrane electrode assembly of Example 3 is the same as that of Example 1, except that polypyrrole is used in place of the sulfonated polyaniline used in Example 1.

The membrane electrode assembly of Example 4 is the same as that of Example 1, except that polythiophene is used in place of the sulfonated polyaniline used in Example 1.

The membrane electrode assembly of Example 5 is the same as that of Example 1, except that polyfluorene is used in place of the sulfonated polyaniline used in Example 1.

The membrane electrode assembly of Example 6 is the same as that of Example 1, except that polyphenylene is used in place of the sulfonated polyaniline used in Example 1.

The membrane electrode assembly of Comparative Example 1 is the same as that of Example 1, except that a 5% (by weight) solution of Nafion (dispersion of perfluorosulfonic acid copolymer, manufactured by Wako Pure Chemical Industries, Ltd.) is used in place of the 5% (by weight) solution of sulfonated polyaniline used in Example 1.

The membrane electrode assembly of Comparative Example 2 is the same as that of Example 1, except that a 5% (by weight) solution of sulfonated polyether sulfone in N-methyl-2-pyrrolidinone is used in place of the 5% (by weight) solution of sulfonated polyaniline used in Example 1.

Cross sections of the membrane electrode assemblies of the above-mentioned Examples 1-6 and Comparative Examples 1 and 2 were examined by means of scanning electron microscope. As a result, it was found that the membrane electrode assemblies of Examples 1-6 showed a good dispersion of the catalyst-carrying carbon and showed a high adhesiveness in that the sulfonated polyether sulfone membrane located at the central position and the electrode catalyst layers were well adhered to each other. In the membrane electrode assembly of Comparative Example 1, however, the sulfonated polysulfone membrane located at the central position and the electrode catalyst layer were peeled off from each other at some positions. Further, in the membrane electrode assembly of Comparative Example 2, the catalyst-carrying carbon showed a more agglomerated tendency as compared with those of Examples 1, indicating its lowness in homogeneous dispersibility.

The membrane electrode assemblies of Examples 1-6 and Comparative Examples 1-2 were formed into fuel cells of FIG. 1. Current-voltage characteristics were measured, while supplying an aqueous solution containing 20% by weight of methanol to the anode electrode side without circulation, and making the cathode electrode contact with air.

FIG. 2 is a drawing demonstrating the relation between voltage and current density of each fuel cell. In the fuel cells of Example 1 and Examples 3-6 using a membrane electrode assembly obtained by electrolytic polymerization, the voltage was 300 mV or higher than 350 mV at a current density of 50 mA/cm², and the voltage was 50 mV or higher than 180 mV at a current density of 120 mA/cm², and high current-voltage characteristics were shown. On the other hand, a fuel cell using the membrane electrode assembly of Example 2 which was not subjected electrolytic polymerization was considerably inferior in the characteristics as compared with that of Example 1.

As has been mentioned above, according to the present example, there can be provided a membrane electrode assembly having a high adhesiveness to proton-conductive aromatic polymer membrane, and having a low interfacial resistance, high voltage-current characteristics and a high performance, and a method for producing the same, a fuel cell using the same and a method for producing the same. Further, the proton-conductive aromatic polymer membrane is suitable for use in a catalyst layer formed as a membrane electrode assembly thereof.

It should be further understood by those skilled in the art that although the foregoing description has been made on embodiments of the invention, the invention is not limited thereto and various changes and modifications may be made without departing from the spirit of the invention and the scope of the appended claims.

1. A membrane electrode assembly equipped with an anode electrode having a catalyst layer on one side surface of a proton-conductive aromatic polyelectrolyte membrane and a cathode electrode having a catalyst layer on the other side surface of said aromatic polyelectrolyte membrane, wherein said catalyst layer has a catalyst and a n-conjugated aromatic polymer having ion exchanging groups on the side chains thereof.

2. A membrane electrode assembly according to claim 1, wherein said proton-conductive aromatic polyelectrolyte membrane is any one member selected from the group consisting of sulfonated polyether ketone, sulfonated polyether sulfone, sulfonated acrylonitrile-butadiene-styrene copolymer and sulfonated polysulfide.

3. A membrane electrode assembly according to claim 1, wherein said n-conjugated aromatic polymer is any one member selected from the group consisting of polyaniline, polypyrrole, polythiophene, polyfluorene and polyphenylene.

4. A membrane electrode assembly according to claim 1, wherein said anode electrode has the above-mentioned catalyst which is a material obtained by dispersing and carrying a mixed fine particle of platinum and ruthenium or a fine particle of platinum-ruthenium alloy on a carbon type powdery carrier.

5. A membrane electrode assembly according to claim 1, wherein said cathode electrode has the above-mentioned catalyst which is a material obtained by dispersing and carrying a fine powder of platinum on a carbon type powdery carrier.

6. A method for producing a membrane electrode assembly comprising a step of forming an anode electrode having, one side surface of a proton-conductive aromatic polyelectrolyte membrane, a catalyst layer comprising a catalyst and a n-conjugated aromatic polymer having ion exchanging groups on the side chains thereof, and a step of forming, on the other side surface of the proton-conductive aromatic polyelectrolyte membrane, a cathode electrode having a catalyst layer comprising a catalyst and a n-conjugated aromatic polymer having ion exchanging groups on the side chains thereof.

7. A method for producing a membrane electrode assembly according to claim 6, wherein said step for forming an anode electrode comprises dispersing a mixed fine particle of platinum and ruthenium or a fine particle of platinum-ruthenium alloy in a solution of said n-conjugated aromatic polymer, adding thereto a carbon type powdery carrier to prepare a slurry, coating the slurry onto one side surface of the electrolyte membrane, drying the coating, and thereafter heating and forming said coating under pressure.

8. A method for producing a membrane electrode assembly according to claim 6, wherein said step for forming the cathode electrode comprises dispersing a fine particle of platinum in a solution of said n-conjugated aromatic polymer, adding thereto a carbon type powdery carrier to prepare a slurry, coating the slurry onto one side surface of said electrolyte membrane, drying the coating, and then heating and forming the coating under pressure.

9. A fuel cell equipped with the membrane electrode assembly according to claim 1, and having a fuel-feeding means for feeding fuel to the anode electrode, an oxidation gas feeding means for feeding oxidation gas to the cathode electrode, a combustion waste gas discharging means for discharging the combustion gas of said fuel, and an oxidation waste gas discharging means for discharging the waste gas of the oxidation gas.

10. A fuel cell comprising a fuel feeding means for feeding a fuel to the anode electrode, an oxidation gas feeding means for feeding oxidation gas to the cathode electrode, a combustion waste gas discharging means for discharging the combustion gas of said fuel, and an oxidation waste gas discharging means for discharging the waste gas of the oxidation gas, wherein said anode electrode has a catalyst layer comprising a catalyst and a n-conjugated aromatic polymer having ion exchanging groups on the side chains thereof on one side surface of a proton-conductive polyelectrolyte, and said cathode electrode has a catalyst layer comprising a catalyst and a n-conjugated aromatic polymer having ion exchanging groups on the side chains thereof, and the catalyst layers are those electrolytically polymerized.

11. A method for producing a fuel cell having a fuel feeding means for feeding a fuel to an anode electrode having, one side surface of a proton-conductive polyelectrolyte membrane, a catalyst layer comprising a catalyst and a n-conjugated aromatic polymer having ion exchanging groups on the side chains thereof, an oxidation gas feeding means for feeding an oxidation gas to a cathode electrode having, on the other side surface of said electrolyte membrane, a catalyst layer comprising a catalyst and a n-conjugated aromatic polymer having ion exchanging groups on side chains thereof, a combustion waste gas discharging means for discharging the waste gas of said fuel, and an oxidation waste gas discharging means for discharging the waste gas of said oxidation gas, characterized by subjecting the catalyst layers to electrolytic polymerization by at least one of steps 1 and 2, wherein the step 1 is a step for giving an electric field of plus electrode to the anode electrode and an electric field of minus electrode to the cathode electrode while feeding a fuel to the cathode electrode, and the step 2 is a step for giving an electric field of minus electrode to the anode electrode and the electric field of plus electrode to the cathode electrode while feeding a fuel to the anode electrode.

12. A method for producing a fuel cell according to claim 11, which has the step 2 after the step 1.
